(19) United States
(12) Patent Application Publication
(10) Pub. No.: US 2021/0096363 A1
(43) Pub. Date: Apr. 1, 2021

(54) NEAR-EYE DISPLAY DEVICE

(71) Applicant: SEOUL NATIONAL UNIVERSITY R&DB FOUNDATION, Seoul (KR)

(72) Inventors: Seung Jae LEE, Gapyeong-gun, Gyeonggi-do (KR); Youngjin JO, Jung-gu, Seoul (KR); Dong Heon YOO, Seo-gu, Daejeon (KR); Jae Bum CHO, Gwangmyeong-si, Gyeonggi-do (KR); Duk Ho LEE, Seongnam-si, Gyeonggi-do (KR); Byoung Ho LEE, Seocho-gu, Seoul (KR)

(21) Appl. No.: 16/971,211

(22) PCT Filed: Feb. 20, 2019
(86) PCT No.: PCT/KR2019/002036

§ 371 Date: Aug. 19, 2020

(30) Foreign Application Priority Data
Feb. 21, 2018 (KR) 10-2018-0020751

(51) Int. Cl. G02B 27/01; G02B 27/30

(52) U.S. Cl. CPC G02B 27/0101; G02B 2027/0187; G02B 27/30

(57) ABSTRACT

The present disclosure relates to a near-eye display device, and more particularly, to a near-eye display device including: a display module configured to reproduce a predetermined image; a lens module positioned in front of the display module for being located between the user's eyes and the display module; and a backlight module positioned behind the display module and providing light to the display module, wherein: the display module induces a convergence response of the user's eyes such that the image may have a predetermined convergence distance; the lens module induces a focusing response of the user's eyes such that a focal distance to the image reproduced by the display module may be varied within a predetermined range; and when the image reproduced by the display module has a specific focal distance by operation of the lens module, the backlight module operates to provide light to the display module such that the image reproduced by the display module may be incident in the user's eyes while having the specific focal distance.

### TECHNICAL FIELD

The present disclosure relates to a near-eye display device, and more particularly, to a near-eye display device including: a display module configured to reproduce a predetermined image; a lens module positioned in front of the display module for being located between the user's eyes and the display module; and a backlight module positioned behind the display module and providing light to the display module, wherein: the display module induces a convergence response of the user's eyes such that the image may have a predetermined convergence distance; the lens module induces a focusing response of the user's eyes such that a focal distance to the image reproduced by the display module may be varied within a predetermined range; and when the image reproduced by the display module has a specific focal distance by operation of the lens module, the backlight module operates to provide light to the display module such that the image reproduced by the display module may be incident in the user's eyes while having the specific focal distance.

### BACKGROUND ART

General binocular near-eye displays use a method in which a virtual image of a general display panel is focused at a remote position from a user by using an optical magnification system. The virtual image for the eyes of the user has appropriate parallax according to a desired depth such that the convergence of the eyes of the user is induced. Each virtual image incident in each of the eyes of the user is a 2D image which does not have depth information and thus does not induce focusing response of the user. Therefore, general binocular near-eye displays using binocular parallax cause focus-convergence distance mismatch.

The convergence response corresponds to the angle at which the directions of both eyes of the user converge, and the focusing response corresponds to the thickness of the lens of each eye of the user. These two responses occur unconsciously depending on the position and depth of an object that the user is looking at, and are related to each other in a reversible and mutual manner. The thickness of the lens of each eye of the user may be adjusted according to the depth the user felt by the convergence response, and the angle between both eyes of the user may be adjusted according to the depth the user felt by the focusing response. Therefore, when the depths to which the two responses are induced are not equal to each other, focus-convergence mismatch occurs in which the user's convergence and focusing responses continuously change.

The focus-convergence mismatch will now be described below with reference to FIG. 1. A focal distance M, which the lenses of the eyeballs adjust, is based on a screen on which an image is formed. However, due to binocular parallax, the angle at which the eyes view an object is based on a position distant from the screen, and thus a convergence distance N is not equal to the focal distance M. When a user is looking at a real object, this focus-convergence distance mismatch does not occur. Techniques using binocular parallax inevitably cause focus-convergence distance mismatch due to the inherent characteristics of the techniques, and since focus-convergence distance mismatch is the main cause of eyestrain, much research has been conducted into focus-convergence distance mismatch.

To resolve the focus-convergence mismatch, a varifocal near-eye display capable of modulating the depth of a virtual image has been proposed. The most representative method thereof is to add a varifocal lens to an optical magnification system to modulate the depth of a physical virtual image. The technical feature of the method is to minimize focus-convergence mismatch by floating a virtual image at an appropriate depth according to the viewpoint of a user.

In the case of varifocal near-eye displays which still show 2D images, complete focusing response is not easily induced, and it is technically difficult to accurately ‘track the viewpoint of a user. In order to compensate for these difficulties, images having different depths may be shown substantially at once in an appropriate time-division manner, but this method causes resolution and frame degradation. Considering that currently-used typical displays are driven at a rate of 60 Hz to 240 Hz, it is possible to show only up to four depths per frame in the case of 60 Hz by using the method. However, when the wide focus range of a user is considered, four depths are insufficient to resolve focus-convergence mismatch. It is possible to express each depth within a range of up to 0.6 diopter (maximum is about 2.4 diopters) by image processing. In this case, however, resolution deterioration occurs.

Therefore, there is a need for a near-eye display device capable of resolving focus-convergence mismatch by a method different from methods of the related art.

### DESCRIPTION OF EMBODIMENTS

### Technical Problem

To resolve the above-mentioned problems, the present disclosure provides a near-eye display device capable of resolving focus-convergence mismatch. Specifically, an objective of the present disclosure is to provide a near-eye display device including: a display module configured to reproduce a predetermined image; a lens module positioned in front of the display module for being located between the user's eyes and the display module; and a backlight module positioned behind the display module and providing light to the display module, wherein: the display module induces a convergence response of the user's eyes such that the image may have a predetermined convergence distance; the lens module induces a focusing response of the user's eyes such that a focal distance to the image reproduced by the display module may be varied within a predetermined range; and when the image reproduced by the display module has a specific focal distance by operation of the lens module, the backlight module operates to provide light to the display module such that the image reproduced by the display module may be incident in the user's eyes while having the specific focal distance.

### Solution to Problem

An embodiment of the present disclosure includes a near-eye display device including: a display module configured to reproduce a predetermined image; a lens module positioned in front of the display module for being located between the user's eyes and the display module; and a backlight module positioned behind the display module and providing light to the display module,

wherein: the display module induces a convergence response of the user's eyes such that the image may have a predetermined convergence distance; the lens module induces a focusing response of the user's eyes such that a focal distance to the image reproduced by the display module may be varied within a predetermined range; and when the image reproduced by the display module has a specific focal distance by operation of the lens module, the backlight module operates to provide light to the display module such that the image reproduced by the display module may be incident in the user's eyes while having the specific focal distance.

Preferably, the image reproduced by the display module has image data and depth data, wherein, when a depth of the image reproduced by the display module is equal to the focal distance by the lens module, the backlight module provides light for focus-convergence matching.

Preferably, the backlight module includes: a plurality of light-emitting elements; and a control device configured to control operations of the plurality of light-emitting elements.

Preferably, the plurality of light-emitting elements are arranged as a predetermined array behind the display module, and the control device is configured to control each of the plurality of light-emitting elements to be binary-driven (on/off driven).

Preferably, when the convergence distance of the image reproduced by the display module is equal to the focal distance by the lens module, the control device performs control to provide light to the backlight module.

Preferably, the backlight module includes: a plurality of light source units; and a mirror module configured to provide reflected light by reflecting light generated by the plurality of light source units, wherein the mirror module includes a mirror unit and a control unit configured to vary an angle of the mirror unit such that the reflected light is selectively incident on the display module.

Preferably, when the convergence distance of the image reproduced by the display module is equal to the focal distance by the lens module, the control unit performs control such that the reflected light from the mirror unit is incident on the display module.

Preferably, the backlight module further includes a collimating lens arranged between the plurality of light source units and the mirror module such that the light generated by the plurality of light source units is incident on the mirror module in a predetermined area.

Preferably, the backlight module further includes an optical module arranged between the mirror module and the display module such that the light reflected from the mirror module is incident on the display module in a predetermined area.

Preferably, the lens module includes a varifocal lens configured to linearly increase or decrease the focal distance of the image reproduced by the display module within the predetermined range.

### Advantageous Effects of Disclosure

The near-eye display device of the present disclosure is configured such that when an image reproduced by the display module has a specific focal distance by the operation of the lens module, the backlight module provides light to the display module. Therefore, the image reproduced by the display module may be incident in the eyes of a user in a state in which the image has a specific focal distance. In addition, when the lens module has other focal distances, light is not provided to the display module such that the image may not be incident in the user's eyes.

Therefore, according to the near-eye display device of the present disclosure, the convergence distance and the focal distance of the image reproduced by the display module may be adjusted to be equal to each other. In other words, when the convergence distance induced by the display module and the focal distance induced by the lens module are equal to each other, the backlight module may be operated. Therefore, the focal distance and the convergence distance may be adjusted to be equal to each other. As a result, focus-convergence mismatch, which is a problem of near-eye display devices of the related art, may be resolved.

### BRIEF DESCRIPTION OF DRAWINGS

FIG. 1 is a schematic view illustrating focus-convergence mismatch.

FIG. 2 is a view illustrating a configuration of a near-eye display device according to an embodiment of the present disclosure.

FIG. 3 is a view illustrating a configuration of the near-eye display device according to an embodiment of the present disclosure.

FIGS. 4 to 5F are views illustrating example operations of the near-eye display device of the present disclosure.

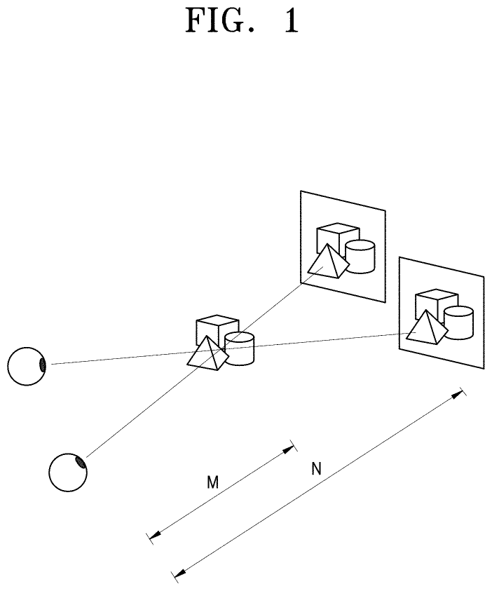

### BEST MODE

The present disclosure relates to a near-eye display device, and more particularly, to a near-eye display device including: a display module configured to reproduce a predetermined image; a lens module positioned in front of the display module for being located between the user's eyes and the display module; and a backlight module positioned behind the display module and providing light to the display module, wherein: the display module induces a convergence response of the user's eyes such that the image may have a predetermined convergence distance; the lens module induces a focusing response of the user's eyes such that a focal distance to the image reproduced by the display module may be varied within a predetermined range; and when the image reproduced by the display module has a specific focal distance by operation of the lens module, the backlight module operates to provide light to the display module such that the image reproduced by the display module may be incident in the user's eyes while having the specific focal distance.

### MODE OF DISCLOSURE

Hereinafter, preferred embodiments of the present disclosure will be described with reference to the accompanying drawings.

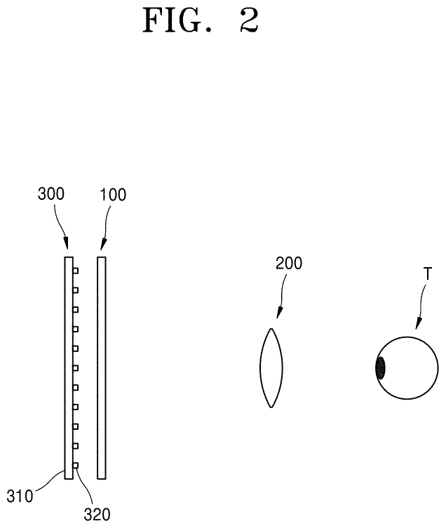

FIG. 2 is a view illustrating a configuration of a near-eye display device according to an embodiment of the present disclosure.

The near-eye display device according to the present disclosure may include a display module 100, a lens module 200, and a backlight module 300.

The display module 100 is a device for reproducing predetermined images. The display module 100 induces the convergence response of the eyes of a user. Therefore, images reproduced by the display module 100 are formed in the user's eyes T with a predetermined convergence distance.

Techniques of the related art may be applied to a device for inducing convergence response and a method of operating the device. A convergence response-inducing device of the display module 100 and a method of operating the device may be modified according to embodiments and are not limited to a specific device and method.

For example, the display module 100 may induce the convergence response of the user's eyes by providing different images to the user's eyes.

For example, in the case of using 3D glasses, an image projected on a screen may be split into images of different colors respectively for the left and right eyes, thereby inducing binocular parallax and convergence response.

In the case of an HMD, for example, a display channel may be divided into two to provide different images to the eyes for inducing binocular parallax and convergence response.

The lens module 200 is arranged in front of the display module 100. Therefore, the lens module 200 is arranged between the user's eyes T and the display module 100.

The lens module 200 induces the focusing response of the user's eyes T. Therefore, images reproduced by the display module 100 are formed in the user's eyes T with a predetermined focal distance.

The lens module 200 may vary the focal distance of the user's eyes T within a predetermined range.

According to an embodiment, the lens module 200 may include a varifocal lens. Therefore, the lens module 200 may linearly increase or decrease the focal distance of the user's eyes T within a predetermined depth range.

In this case, the varifocal lens may sweep the predetermined depth range at a rate of 60 times per second. Here, 1/60 second may be said to be one frame. Therefore, the focal distance may be adjusted by the varifocal lens once per frame within the predetermined depth range, and may also be adjusted by the varifocal lens 60 times per second within the predetermined depth range.

For example, the focal distance of the varifocal lens may be linearly increased from 50 mm to 120 mm for 1/120 second, and may then be returned to 50 mm for 1/120 second. In this case, a virtual image reproduced by the display module 100 via the varifocal lens may sweep within a range of 00 m to 8.5 cm. Because 1/60 second is a time period corresponding to one frame observed by a viewer, a user may recognize images projected during the time period as one temporally combined image.

The varifocal lens may have any structure for varying the focal distance as described above. For example, the varifocal lens may have a structure in which the position of a lens is linearly variable, a structure in which the thickness of a lens is variable, or a structure in which a plurality of lenses are provided with a variable distance therebetween.

However, the varifocal lens is not limited thereto, and when a specific optical system or physical system has the above-mentioned function, the specific optical system or physical system may be used instead of the varifocal lens. In addition, the varifocal lens may be replaced with another varifocal optical system for another field of view, eye-box, or the like. For example, a method of locating a varifocal lens in an optical relay system may be used.

The backlight module 300 is arranged behind the display module 100 to provide light to the display module 100.

FIG. 2 is a view illustrating a configuration of the backlight module 300 of the near-eye display device according to an embodiment of the present disclosure. The backlight module 300 of the near-eye display device according to the embodiment of the present disclosure may include a PCB 310 and a plurality of light-emitting elements 320 mounted on the PCB 310. In addition, a control device (not shown) may be provided to control the operations of the light-emitting elements 320.

The PCB 310 may be arranged behind the display module 100, and the light-emitting elements 320 may be mounted on the PCB 310 and may emit light toward the display module 100. The light-emitting elements 320 may be mounted on the PCB 310 in a predetermined array form. That is, a predetermined number of light-emitting elements 320 may be arranged per unit area, for example, one light-emitting element 320 per pixel.

The control device controls the light-emitting elements 320 such that each of the light-emitting elements 320 may be binary-driven (on/off driven). Therefore, each of the light-emitting elements 320 may be turned on/off by the control device.

Therefore, when a light-emitting element 320 located in a specific pixel is turned off, an image of a pixel of the display module 100 located at a position corresponding to the position of the light-emitting element 320 is not incident in the user's eyes T. Conversely, when the light-emitting element 320 located in the specific pixel is turned on, the image of the pixel of the display module 100 located at a position corresponding to the position of the light-emitting element 320 is incident in the user's eyes T.

In addition, the control device may turn on/off each of the light-emitting elements 320 at a specific time. That is, an image of the display module 100 enters the user's eyes T when the light-emitting elements 320 are turned on, and does not enter the user's eyes T when the light-emitting elements 320 are turned off.

Preferably, the light-emitting elements 320 may be binary-driven by the control device at a binary driving rate of 60 Hz or more. That is, multiple on/off operations may be possible during one frame, and spatial modulation may be possible by on/off operations. For example, assuming that the spatial modulation response time of the backlight module 300 is 1/6000 second (6000 Hz), spatial modulation may be performed by each of the light-emitting elements 320 100 times per frame.

That is, as described above, the lens module 200 includes the varifocal lens that linearly increases or decreases the focal distance of the user's eyes T within the predetermined depth range, and for example, the focal distance may be reciprocated once per frame within the predetermined depth range. In addition, when an image reproduced by the display module 100 has a specific focal distance by the operation of the varifocal lens, the backlight module 300 may provide light such that the image reproduced by the display module 100 may be incident in the user's eyes T while having the specific focal distance. In this case, the time when the backlight module 300 provides light may be adjusted such that the focal distance by the varifocal lens may be equal to the convergence distance by the display module 100. Therefore, the user may be provided with an image having a focal distance and a convergence distance which are equal to each other. That is, mismatch between the convergence distance and the focal distance may be resolved.

Preferably, the operation of the lens module 200 may be synchronized with the operations of the light-emitting elements 320 by the control device. For example, the control device may operate such that light may be provided to the display module 100 when a convergence distance to an image reproduced by the display module 100 is equal to the focal distance to the image by the lens module 200.

For example, an image reproduced by the display module 100 may have predetermined image data and convergence distance data. Therefore, the control device may operate such that the light-emitting elements 320 may provide light when the convergence distance of an image stored in the display module is equal to the focal distance by the lens module 200. Therefore, the control device may include a predetermined control algorithm. That is, the control algorithm of the control device may operate the light-emitting elements when the lens module 200 has a specific focal distance.

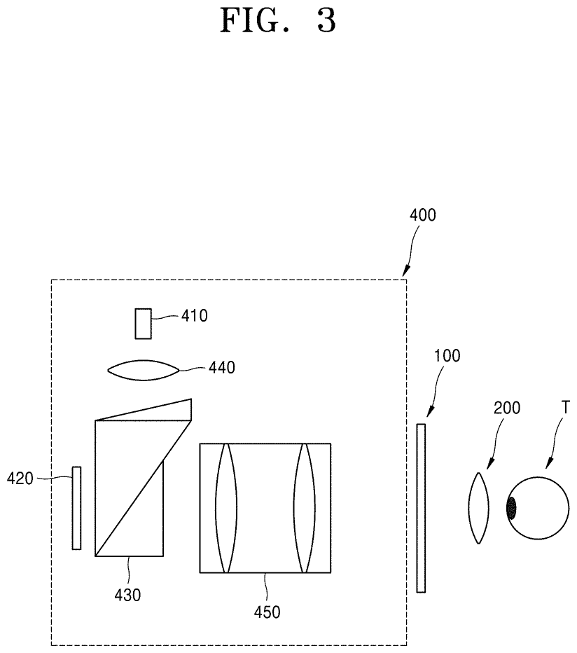

FIG. 3 is a view illustrating a configuration of the near-eye display device according to an embodiment of the present disclosure. In the present embodiment, the display device 100 and the lens module 200 are the same as described above, and only a backlight module 400 is different. Thus, the backlight module 400 will be mainly described without a repeated description of the display module 100 and the lens module 200.

The backlight module 400 of the near-eye display device according to the embodiment of the present disclosure includes a light source unit 410, a mirror module 420, a prism module 430, a collimating lens 440, and an optical module 450.

The light source unit 410 may be located at a position in the backlight module 400. The light source unit 410 may include a PCB and light-emitting elements. For example, the light source unit 410 may be placed on a side of the backlight module 400 and may emit light toward the inside of the backlight module 400.

The mirror module 420 reflects light generated by the light source unit 410. The mirror module 420 may include: a plurality of mirror units that reflect light and have variable orientation angles; and a control unit that controls the orientation angles of the mirror units. The mirror units may be arranged in a predetermined array form. That is, a predetermined number of mirror units may be arranged per unit area. That is, one mirror unit may be arranged in each pixel. In addition, the control unit may control the orientation angle of each of the mirror units.

For example, the mirror module 420 may include small digital mirror devices (DMDs).

Preferably, the control unit may drive the mirror units at a rate of 60 Hz or greater. That is, multiple operations may be possible during one frame, and spatial modulation may be possible by such operations. For example, assuming that the modulation response time of the mirror units is 1/6000 second (6000 Hz), each of the small DMDs may perform modulation 100 times per frame.

The meaning of the spatial modulation will now be described in more detail.

The lens module 200 including the varifocal lens scans a predetermined depth range 60 times per second. The varifocal lens may continuously repeat this operation, and an appropriate motion picture may be reproduced on the display module 100 at 60 Hz. In this case, for 1/60 second, that is, during one frame, the varifocal lens may reciprocate a predetermined depth range once, and a still image may be reproduced on the display module 100. When the backlight module 400 provides light to all pixels at a fixed value, the still image is uniformly observed at all depths. However, in the near-eye display device of the present disclosure, the backlight module may operate a plurality of times per one frame to provide light only at specific timings. Thus, for example, the expression “100 repetitions of spatial modulation is possible” means that it is possible for the backlight module 400 to provide light by equally dividing the depth the varifocal lens reciprocates into 100 sections. If light is provided to a pixel at a determined depth, focusing response may be precisely induced.

The prism module 430 may be arranged between the light source unit 410 and the mirror module 420 and between the mirror module 420 and the optical module 450. Owing to the prism module 430, light generated by the light source unit 410 may be incident on the mirror module 420 in a predetermined area in a predetermined direction, or light reflected from the mirror module 420 may be incident on the optical module 450. In addition, the optical path of light generated by the light source unit 410 and the optical path of light reflected from the mirror module 420 may be effectively separated, and the size of the entire system may be reduced.

The collimating lens 440 may be positioned between the prism module 430 and the light source unit 410. The collimating lens 440 may collimate light to be incident on the mirror module 420 into parallel rays. That is, because normal light radiates, optical loss may occur, but such loss may be minimized by reducing the divergence angle of light by using the collimating lens 440.

The optical module 450 may be arranged between the mirror module 420 and the display module 100. Owing to the optical module 450, light reflected from the mirror module 420 may be incident on the display module 100 in a predetermined area.

The optical module 450 may be an optical magnification and relay system. The optical magnification and relay system expand a DMD plane and relay the DMD plane to a display plane. In the present embodiment, the DMDs of the mirror module 420 have the function of a high-speed backlight capable of spatial modulation. In the present embodiment, the prism module 430 is provided between the display module 100 and the mirror module 420, and thus, it may be difficult to form a structure in which a backlight and a display panel is in direct contact with each other as described above. Therefore, the optical module 450 constituted by an optical relay system is provided to obtain the effect in which the DMDs are considered as if the DMDs are directly on the display module 100. In addition, when the optical module 450 performs a magnification function, the DMDs may function as a backlight which is larger than the actual size (1 inch) of the DMDs.

The operation of the backlight module 400 will now be described according to the embodiment.

The light source unit 410 emits light toward the prism module 430. The prism module 430 refracts the light emitted by the light source unit 410 toward the mirror module 420.

The mirror module 420 may reflect light generated by the light source unit 410 in a direction toward the display module 100 or in another direction. Therefore, the reflected light is selectively incident on the display module 100.

The light reflected from the mirror module 420 toward the display module 100 passes through the optical module 450. In this case, the light reflected from the mirror module 420 may pass through the prism module 430 again before passing through the optical module 450. While the light passes through the prism module 430 and the optical module 450 as described above, the light may be optically modulated. For example, the light may be modulated to have an appropriate light distribution area, and the modulated light may be provided to the display module 100.

As the mirror module 420 reflects light generated by the light source unit 410 in the direction toward the display module 100, the light is provided to the display module 100, and an image is incident in the user's eyes T. Alternatively, when the mirror module 420 reflects light generated by the light source unit 410 in another direction, no light is provided to the display module 100, and thus, no image is incident in the user's eyes T. Therefore, operations similar to on/off operations of the light source unit 410 may be performed according to the operation of the mirror module 420.

Preferably, the control unit may drive the mirror module 420 at a rate of 60 Hz or greater.

That is, as described above, the lens module 200 includes the varifocal lens that linearly increases or decreases the focal distance of the user's eyes T within the predetermined depth range, and for example, the focal distance may be reciprocated once per frame within the predetermined depth range. In addition, when an image reproduced by the display module 100 has a specific focal distance by the operation of the varifocal lens, the mirror module of the backlight module 400 may be operated to provide light such that the image reproduced by the display module 100 may be incident in the users eyes T while having the specific focal distance. In this case, the time when the backlight module 400 provides light may be adjusted such that the focal distance by the varifocal lens and a convergence distance may be adjusted to be equal to each other. Therefore, the user may be provided with an image having a focal distance and a convergence distance which are equal to each other. That is, focus-convergence distance mismatch may be resolved.

Preferably, the operation of the lens module 200 may be synchronized with the operations of the mirror units by the control unit. For example, the control unit may operate such that light may be provided to the display module 100 when a convergence distance to an image reproduced by the display module 100 is equal to the focal distance of the image by the lens module 200. To this end, the control unit may include a predetermined control algorithm. That is, the control algorithm of the control unit may operate the light-emitting elements when the lens module 200 has a specific focal distance.

As in the previous embodiment, an image reproduced by the display module 100 may have predetermined image data and convergence distance data. Therefore, the control unit may operate such that the mirror module 420 may provide light to the display module 100 when the convergence distance to an image stored in the display module is equal to the focal distance by the lens module 200. To this end, the control unit may include a predetermined control algorithm. That is, the control algorithm of the control unit may operate the mirror units to provide light to the display module 100 when the lens module 200 has a specific focal distance.

Therefore, the user may be provided with an image having a focal distance and a convergence distance which are adjusted to be equal to each other. That is, focus-convergence mismatch may be resolved.

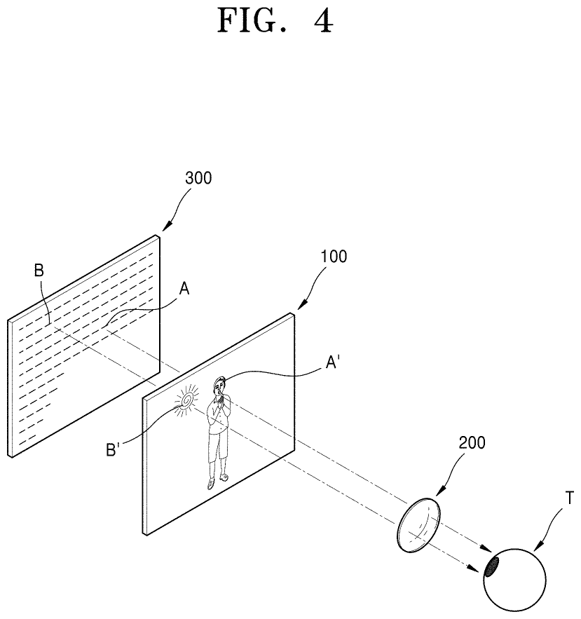

The operation of the near-eye display device of the present disclosure will now be described with reference to FIG. 4. Here, for ease of description, the operation of the backlight module 300 will be described according to a first embodiment.

A 3D image to be expressed by the display module has a 2D image and depth information for each frame. Here, the depth information means a convergence distance. The 2D image, which is the same as an original image, is reproduced on the display module 100. The image is provided to a user with intact brightness only when the backlight module 300 provides light. The depth information determines a depth at which the light-emitting elements 320 arranged in pixels of the backlight module 300 are turned on.

When the depth to be expressed by pixels A′ of an image reproduced on the display module 100 is 1 m, the lens module 200 implements a focal distance of 1 m, and light is provided by light-emitting elements 320 of the backlight module 300, which are in pixels A corresponding to the pixels A′. In addition, when the depth to be expressed by pixels B′ of an image reproduced on the display module 100 is 100 m, the lens module 200 implements a focal distance of 100 m, and light is provided by light-emitting elements 320 of the backlight module 300, which are in pixels B corresponding to the pixels B′.

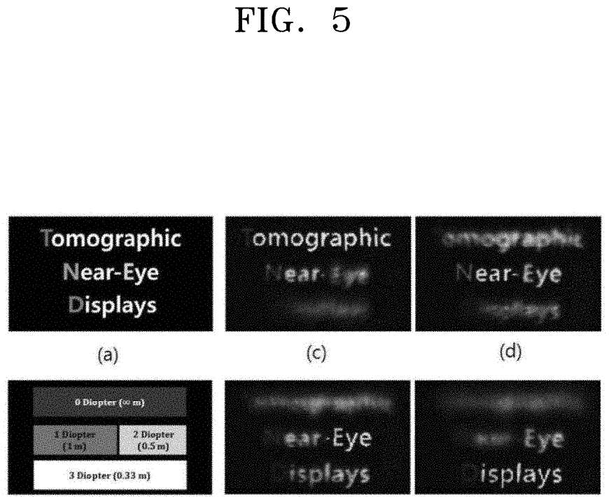

FIGS. 5A to 5F are views illustrating an operation example of the present disclosure.

First, FIG. 5A shows an image generated by the display module 100, and FIG. 5B shows a depth information image of each region. As described above, the image generated by the display module has 2D image data and depth data (focus distance data) of each region of the image data.

FIGS. 5C, 5D, 5E, and 5F respectively show focal points at 0 diopter, 1 diopter, 2 diopters, and 3 diopters. The backlight module operates at a focal distance that matches the focal distance data stored for each region, such that the image of the display module may be provided to a user.

Hereinafter, effects of the present disclosure will be described.

The near-eye display device of the present disclosure is configured such that when an image reproduced on the display module 100 has a specific focal distance by the operation of the lens module 200, the backlight module 300 provides light to the display module 100. Therefore, the image reproduced on the display module 100 may be incident on the user's eyes T in a state in which the image has a specific focal distance. In addition, when the lens module 200 has other focal distances, light is not provided to the display module 100 such that the image may not be incident on the user's eyes T.

Therefore, the near-eye display device of the present disclosure may adjust the convergence distance and the focal distance of the image reproduced on the display module 100 to be equal to each other. In other words, when the convergence distance induced by the display module 100 and the focal distance induced by the lens module 200 are equal to each other, the backlight module 300 may be operated to provide the condition in which the focal distance and the convergence distance are equal to each other. Therefore, focus-convergence mismatch, which is a problem of near-eye display devices of the related art, may be resolved.

In addition, the near-eye display device of the present disclosure may express 100 depths or more based on currently commercialized technology, and thus, focus-convergence mismatch may be more securely resolved.

Furthermore, the near-eye display device of the present disclosure may prevent loss of resolution.

For example, when a display device of the related art, which is not capable of resolving focus-convergence mismatch, is in a focus-convergence mismatch state in which convergence is proper but focusing is not correct, an object to be clearly seen may be blurred, and resolution loss may occur. According to the technique of the present disclosure, however, focus-convergence mismatch is resolved, and thus, resolution loss does not occur.

As another example, considering a focus-inducing display device of the related art that provides an image having two or more depth planes and enables continuous focusing between the depth planes to resolve focus-convergence mismatch, the depth planes have a certain depth difference therebetween, and thus resolution is sacrificed to enable focusing between the depth planes having a certain depth difference. According to the technology of the present disclosure, however, a plurality of depth planes (100 or more depth planes) are almost continuously expressed instead of expressing a limited number of depth planes such as two to four depth planes, and thus, the depth difference between the depth planes is very small such that there may be substantially no resolution loss. That is, the near-eye display device of the present disclosure has substantially no resolution loss unlike display devices of the related art which express a limited number of depths.

In addition, the near-eye display device of the present disclosure may correct the astigmatic field curvature of an optical system by using the degree of freedom in a depth direction. Astigmatic field curvature is optical aberration caused by the focal plane depth difference between a peripheral region and a center region of an image. The near-eye display device of the present disclosure may correct this optical aberration by previously calculating and reflecting the degree of the optical aberration. For example, when a focal plane is closer in a center region than in a peripheral region, astigmatic field curvature may be corrected by providing light to a display panel at a time the display panel is relatively slightly distant in the center region.

Although preferred embodiments have been described with reference to the accompanying drawings, the present disclosure is not limited to the embodiments, and it will be apparent to those of ordinary skill in the art that various modifications may be made therein without departing from the spirit and scope of the present disclosure defined by the following claims, and such modifications should not be individually understood from the technical idea or scope of the present disclosure.

1. A near-eye display device comprising:
a display module configured to reproduce a predetermined image;
a lens module positioned in front of the display module for being located between the user's eyes and the display module; and
a backlight module positioned behind the display module and providing light to the display module,
wherein the display module induces
a convergence response of the user's eyes such that the image has a predetermined convergence distance,
the lens module induces
a focusing response of the user's eyes such that a focal distance to the image reproduced by the display module is varied within a predetermined range, and
when the image reproduced by the display module has a specific focal distance by operation of the lens module,
the backlight module operates to provide light to the display module such that the image reproduced by the display module is incident in the user's eyes while having the specific focal distance.

2. The near-eye display device of claim 1, wherein the image reproduced by the display module has image data and depth data,
wherein when a depth of the image reproduced by the display module is equal to the focal distance by the lens module,
the backlight module provides light for focus-convergence matching.

3. The near-eye display device of claim 1, wherein the backlight module comprises:
a plurality of light-emitting elements; and
a control device configured to control operations of the plurality of light-emitting elements.

4. The near-eye display device of claim 3,
wherein the plurality of light-emitting elements are arranged as a predetermined array behind the display module, and
the control device is configured to control each of the plurality of light-emitting elements to be binary-driven (on/off driven).

5. The near-eye display device of claim 4, wherein when the convergence distance of the image reproduced by the display module is equal to the focal distance by the lens module, the control device performs control to provide light to the backlight module.

6. The near-eye display device of claim 1, wherein the backlight module comprises:
a plurality of light source units; and
a mirror module configured to provide reflected light by reflecting light generated by the plurality of light source units,
wherein the mirror module comprises a mirror unit and a control unit configured to vary an angle of the mirror unit such that the reflected light is selectively incident on the display module.

7. The near-eye display device of claim 6, wherein, when the convergence distance of the image reproduced by the display module is equal to the focal distance by the lens module, the control unit performs control such that the reflected light from the mirror unit is incident on the display module.

8. The near-eye display device of claim 6, wherein the backlight module further comprises a collimating lens arranged between the plurality of light source units and the mirror module such that the light generated by the plurality of light source units is incident on the mirror module in a predetermined area.

9. The near-eye display device of claim 6, wherein the backlight module further comprises an optical module arranged between the mirror module and the display module such that the light reflected from the mirror module is incident on the display module in a predetermined area.

10. The near-eye display device of claim 1, wherein the lens module comprises a varifocal lens configured to linearly increase or decrease the focal distance of the image reproduced by the display module within the predetermined range.
